(19) United States
(12) Patent Application Publication
(10) Pub. No.: US 2006/0168211 A1
(43) Pub. Date: Jul. 27, 2006

(54) Information processing system, information processing device and method, program storage medium, and program

(76) Inventor: Hiroyuki Koike, Kanagawa (JP)

Correspondence Address: BELL, BOYD & LLOYD, LLC, P. O. BOX 1135, CHICAGO, IL, 60690-1135, US

(21) Appl. No.: 10/525,187

(22) PCT Filed: Aug. 28, 2003
(86) PCT No.: PCT/JP03/10898

§ 371 Date: Feb. 22, 2005

(30) Foreign Application Priority Data
Aug. 29, 2002 (JP) 2002-251015

(51) Int. Cl. G06F 15/173; G06F 15/16

(52) U.S. Cl. 709/225; 709/219

(57) ABSTRACT

The present invention relates to an information processing system, an information processing device and a method, a program storage medium, and a program which allow content to be distributed according to a user's action. A content server transmits a content URI corresponding to an action processable by an application server to the application server. When a user performs an action, an application client transmits an action message to the application server. In accordance with the action message, the application server transmits the address of the content receiver and a content URI to the content server. The content server distributes content to a content receiver. The present invention is applicable to a system that distributes content over the Internet.

### BACKGROUND OF THE INVENTION

The present invention relates to information processing systems, information processing devices and methods, program storage media, and programs. In particular, the present invention relates to an information processing system, an information processing device and a method, a program storage medium, and a program which can ensure the distribution of content useful for users.

Recently, with the widespread availability of the Internet, users can obtain various types of information through the use thereof. Business entities that wish to supply various types of information also may supply information they wish to supply to users over the Internet.

However, since too much information can be obtained, it is difficult for general users to obtain only that information they want. Thus, a system has been proposed in which each general user pre-registers his/her preference information with a predetermined server, the server acquires information that meets the preference, and the user accesses the server so that he/she can obtain only information that meets his/her preference.

In such a system, however, each user must register his/her preference information, thereby providing a large load on the user, so that the user does not use the system after all in many cases.

In addition, in order to have as many users as possible to actually listen to and/or view information, the information provider needs to supply the information to as many users as possible. However, with the system described above, the preference information of each user cannot be known from a device other than the server in which the users' preference information is registered. Thus, there is a problem in that information cannot be efficiently distributed.

### SUMMARY OF THE INVENTION

The present invention has been made in view of such a situation, wherein the present invention seeks to allow content to be promptly, reliably, and efficiently distributed to users.

The present invention provides an information processing system. A first information processing device includes a first receiver for receiving access information from a second information processing device, a first holding part for holding the access information received by the first receiver, and a first transmitter for transmitting the action information corresponding to the access information to a third information processing device. A second information processing device includes a first acquiring part for acquiring the action information processable by the third information processing device, a second transmitter for transmitting the access information corresponding to the action information to the first information processing device, a second receiver for receiving an address of a device with which an action was performed and the access information corresponding to the performed action from the third information processing device, and a third transmitter for transmitting content to the address in accordance with the access information received by the second receiver. A third information processing device includes a third receiver for receiving the access information and the action information corresponding to the access information from the first information processing device, a second holding part for holding the access information so as to correspond to the action information received by the third receiver, a second acquiring part for acquiring the address of the device with which the action was performed, the action and the action information, a retriever for retrieving the access information corresponding to the action information from the information held by the second holding part, and a fourth transmitter for transmitting the address acquired by the second acquiring part and the access information retrieved by the retriever to the second information processing device.

The present invention also provides an information processing method for an information processing system. The information processing method for a first information processing device includes a first receiving step of receiving the access information from the second information processing device, a first holding step of holding the access information received in the processing of the first receiving step, and a first transmitting step of transmitting the action information corresponding to the access information to the third information processing device. The information processing method for a second information processing device includes a first acquiring step of acquiring the action information processable by the third information processing device, a second transmitting step of transmitting the access information corresponding to the action information to the first information processing device, a second receiving step of receiving an address of a device with which an action was performed and the access information corresponding to the performed action from the third information processing device, and a third transmitting step of transmitting content to the address in accordance with the access information received in the processing of the second receiving step. The information processing method for a third information processing device includes a third receiving step of receiving the access information and the action information corresponding to the access information from the first information processing device, a second holding step of holding the access information so as to correspond to the action information received in the processing of the third receiving step, a second acquiring step of acquiring the address of the device with which the action was performed the action and the action information, a retrieving step of retrieving the access information corresponding to the action information from the information held in the processing of the second holding step, and a fourth transmitting step of transmitting the address acquired in the processing of the second acquiring step and the access information retrieved in the processing of the retrieving step to the second information processing device.

The present invention also provides a first information processing device. The device includes a first receiver for receiving access information for accessing content from a first another information processing device, a first holding part for holding the access information received by the first receiver, and a first transmitter for transmitting action information corresponding to the access information to a second another information processing device.

The first information processing device may further include a determining part for determining an ID corresponding to the access information received by the first receiver. The first holding part holds the access information and the ID.

The first information processing device may further include a second receiver for receiving an address of a device with which an action was performed and the ID corresponding to the action from the second another information processing device, a detector for detecting the access information corresponding to the ID from the first holding part, and a second transmitter for transmitting the address and the access information to the first another information processing device.

The first information processing device may further include a third receiver for receiving an action processable by the second another information processing device from the second another information processing device, and a second holding part for holding the action received by the third receiver.

The first information processing device may further include a fourth receiver for receiving a request for acquiring the action from the first another information processing device, and a third transmitter for transmitting the action held by the second holding part to the first another information processing device.

The present invention also provides a first information processing method. The method includes a receiving step of receiving the access information from the first another information processing device, a holding step of holding the access information received in the processing of the receiving step, and a transmitting step of transmitting action information corresponding to the access information to second another information processing device.

The present invention also provides a first program storage medium. A program in the first program storage medium includes a receiving step of receiving the access information from the first another information processing device, a hold controlling step of controlling holding of the access information received in the processing of the receiving step, and a transmitting step of transmitting action information corresponding to the access information to the second another information processing device.

The present invention also provides a first program. The first program causes a computer to execute a receiving step of receiving the access information from the first another information processing device, a hold controlling step of controlling holding of the access information received in the processing of the receiving step, and a transmitting step of transmitting action information corresponding to the access information to the second another information processing device.

The present information also provides a second information processing device. The second information processing device includes an acquiring part for acquiring action information processable by a first another information processing device, a first transmitter for transmitting access information corresponding to the action information to a second another information processing device, a receiver for receiving an address of a device with which an action was performed and the access information corresponding to the performed action from the first another information processing device, and a second transmitter for transmitting content to the address in accordance with the access information received by the receiver.

The present invention also provides a second information processing method. The method includes an acquiring step of acquiring action information processable by second another information processing device, a first transmitting step of transmitting the access information corresponding to the action information to the first another information processing device, a receiving step of receiving an address of a device with which an action was performed and the access information corresponding to the performed action from the second another information processing device, and a second transmitting step of transmitting content to the address in accordance with the access information received in the processing of the receiving step.

The present invention also provides a second program storage medium. A program in the storage medium includes an acquiring step of acquiring action information processable by a second another information processing device, a first transmitting step of transmitting the access information corresponding to the action information to the first another information processing device, a receiving step of receiving an address of a device with which an action was performed and the access information corresponding to the performed action from the second another information processing device, and a second transmitting step of transmitting content to the address in accordance with the access information received in the processing of the receiving step.

The present invention also provides a second program. The program causes a computer to execute an acquiring step of acquiring action information processable by a second another information processing device, a first transmitting step of transmitting the access information corresponding to the action information to the first another information processing device, a receiving step of receiving an address of a device with which an action was performed and the access information corresponding to the performed action from the second another information processing device, and a second transmitting step of transmitting content to the address in accordance with the access information received in the processing of the receiving step.

The present invention also provides a third information processing device. The device includes a first receiver for receiving access information and action information corresponding to the access information from a first another information processing device, holding part for holding the access information so as to correspond to the action information received by the first receiver, an acquiring part for acquiring the action information and an address of a device with which the action is performed, retriever for retrieving the access information corresponding to the action information from the information held by the holding part, and first transmitter for transmitting the address acquired by the acquiring part and the access information retrieved by the retriever to a second another information processing device.

The third information processing device may further include a second transmitter for transmitting a processable action to the first another information processing device.

The third information processing device may further include a second receiver for receiving the access information and an ID corresponding to the access information from the first another information processing device, a second retriever for retrieving the same access information as the access information received by the second receiver, from the holding part, and a storing part for storing the ID so as to correspond to the access information retrieved by the second retriever.

The present invention also provides a third information processing method. The method includes a receiving step of receiving access information and action information corresponding to the access information from a first another information processing device, a holding step of holding the access information so as to correspond to the action information received in the processing of the first receiving step, an acquiring step of acquiring an address of a device with which an action was performed and the action information, a retrieving step of retrieving the access information corresponding to the action information from the information held in the processing of the holding step, and a transmitting step of transmitting the address acquired in the processing of the acquiring step and the access information retrieved in the processing of the retrieving step to a second another information processing device.

The present invention also provides a third program storage medium. A program in the storage medium includes a receiving step of receiving access information and action information corresponding to the access information from a first another information processing device, a hold controlling step of controlling holding of the access information so as to correspond to the action information received in the processing of the first receiving step, an acquisition controlling step of controlling acquisition of an address of a device with which an action was performed and the action information, a retrieving step of retrieving the access information corresponding to the action information from the information held in the processing of the hold controlling step, and a transmitting step of transmitting the address acquired in the processing of the acquisition controlling step and the access information retrieved in the processing of the retrieving step to a second another information processing device.

The present invention also provides a third program. The program causes a computer to execute a receiving step of receiving access information and action information corresponding to the access information from a first another information processing device, a hold controlling step of controlling holding of the access information so as to correspond to the action information received in the processing of the first receiving step, an acquisition controlling step of controlling acquisition of an address of a device with which an action was performed and the action information, a retrieving step of retrieving the access information corresponding to the action information from the information held in the processing of the hold controlling step, and a transmitting step of transmitting the address acquired in the processing of the acquisition controlling step and the access information retrieved in the processing of the retrieving step to a second another information processing device.

In the first information processing device and method, the program storage medium, and the program according to the present invention, access information is received from the first information processing device and action information corresponding to the access information is transmitted to the second another information processing device.

In the second information processing device and method, the program storage medium, and the program according to the present invention, action information processable by the first another information processing device is acquired and access information corresponding to the action information is transmitted to the second another information processing device. The address of a device with which the action was performed and the access information corresponding to the performed action are received from the first another information processing device and content is transmitted to the address in accordance with the received access information.

In the third information processing device and method, the program storage medium, and the program according to the present invention, access information and action information corresponding to the access information are received from the first another information processing device. The access information is held so as to correspond to the received action information, and the address of a device with which the action was performed and the action information are acquired. Access information corresponding to the action information is retrieved from the held information and the acquired address and the retrieved access information are transmitted to the second another information processing device.

Additional features and advantages of the present invention are described in, and will be apparent from, the following Detailed Description of the Invention and the Figures.

### BRIEF DESCRIPTION OF THE FIGURES

FIG. 1 is a diagram showing the configuration of an embodiment of an information distribution system of the present invention.

FIG. 2 is a diagram showing the configuration of the information distribution system shown in FIG. 1.

FIG. 3 is a flow chart illustrating processing in which a web server transmits an action element.

FIG. 4 is a table showing examples of data stored in an action element DB of an application server.

FIG. 5 is a table showing an example of information transmitted from the web server to the action element DB of the service server.

FIG. 6 is a flow chart illustrating processing in which the service server performs registration into the action element DB.

FIG. 7 is a table showing examples of data stored in an action element DB of the service server.

FIG. 8 is a flow chart illustrating processing in which a trigger-element registry client acquires an action element.

FIG. 9 is a table showing an example of a message that the trigger-element registry client transmits to a trigger-element registry server.

FIG. 10 is a table showing an example of an action element group acquired by the trigger-element registry client.

FIG. 11 is a flow chart illustrating processing in which the trigger-element registry client transmits a content URI.

FIG. 12 is a table showing an example of information that the trigger-element registry client transmits to the trigger-element registry server.

FIG. 13 is a flow chart illustrating processing in which the trigger-element registry server acquires a trigger ID.

FIG. 14 is a table showing an example of information that the trigger-element registry server transmits to the web server.

FIG. 15 is a flow chart illustrating processing in which the trigger-element DB determines a trigger ID.

FIG. 16 is a table showing examples of data stored in the trigger-element DB.

FIG. 17 is a flow chart illustrating processing in which the web server registers a trigger ID.

FIG. 18 is a table showing examples of data stored in the action element DB of the application server.

FIG. 19 is a flow chart illustrating processing in which the application server receives an action message.

FIG. 20 is a flow chart illustrating processing in which a trigger manager receives a user ID and a trigger ID.

FIG. 21 is a table showing examples of data stored in a user-address DB.

FIG. 22 is a flow chart illustrating processing in which a content sender distributes content.

FIG. 23 is a chart illustrating the operation of the information processing system of the present invention.

FIG. 24 is a block diagram showing another configuration of the information distribution system shown in FIG. 1.

FIG. 25 is a block diagram showing still another configuration of the information distribution system shown in FIG. 1.

FIG. 26 is a bock diagram showing the internal configuration of a computer.

### DETAILED DESCRIPTION OF THE INVENTION

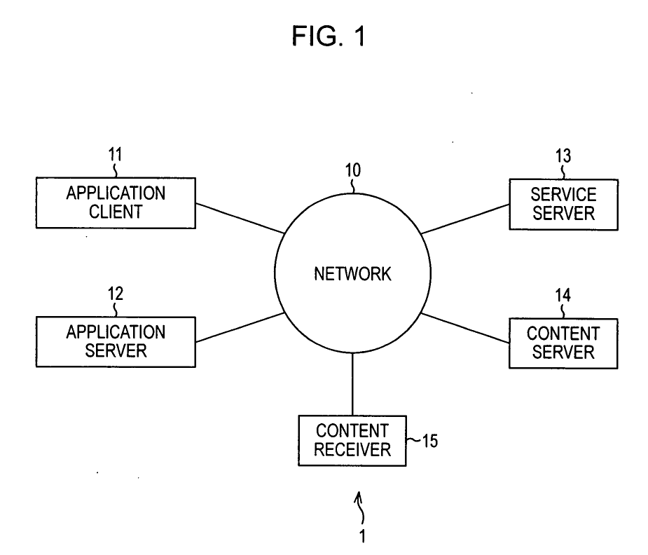

Embodiments of the present invention will be described below with reference to the accompanying drawings. FIG. 1 is a block diagram showing an example of the configuration of one embodiment of an information distribution system according to the present invention.

In an information distribution system 1, an application client 11, an application server 12, a service server 13, a content server 14, and a content receiver 15 are interconnected over a network 100 including the Internet.

The service server 13 determines a trigger ID for an action. The application server 12 registers the trigger ID determined by the service server 13. When an action is input from a user, the application client 11 issues a notification to the application server 12. Upon receiving the notification, the application server 12 transmits a user ID and a trigger ID corresponding to the action to the service server 13. The service server 13 transmits the address of the content receiver 15 corresponding to the user ID and a content URI corresponding to the trigger ID to the content server 14. In accordance with the content URI, the content server 14 distributes content to the content receiver 15 at the received address.

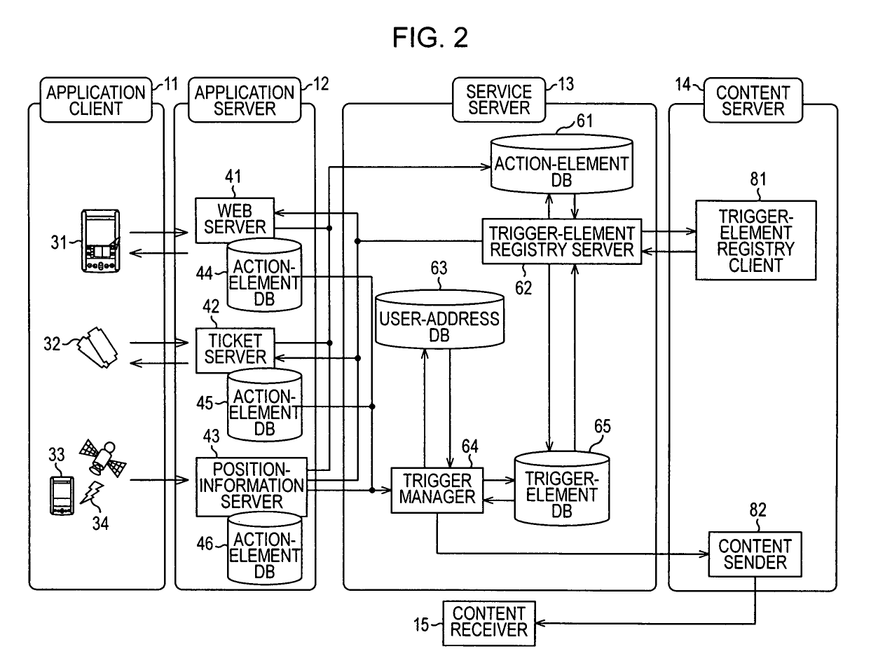

FIG. 2 shows the configuration of individual units of the information distribution system according to the present invention. The application client 11 includes, for example, a web browser 31, a ticket client 32, a GPS (Global Positioning System) receiver 33, and a GPS satellite 34. The application server 12 includes a web server 41 and an action-element DB (database) 44 which correspond to the web browser 31, a ticket server 42 and an action-element DB 45 which correspond to the ticket client 32, and a position-information server 43 and an action-element DB 46 which correspond to the GPS receiver 33.

An action-element DB 61 receives and registers action elements (described below) of actions that can be processed by the web server 41, the ticket server 42, and the position-information server 43 of the application server 12.

When a trigger-element registry server 62 receives a request for acquiring an action element group from a trigger-element registry client 81 of the content server 14, the trigger-element registry server 62 acquires an action element group from the action-element DB 61 and transmits the action element group to the trigger-element registry client 81. The trigger-element registry client 81 selects an action element from the received action element group and issues, to the trigger-element registry server 62, a request for registering a content URI for the selected action element (trigger element).

Upon receiving the request for registering the content URI from the trigger-element registry client 81, the trigger-element registry server 62 transmits the content URI to a trigger-element DB 65.

Upon receiving the content URI from the trigger-element registry server 62, the trigger-element DB 65 determines a trigger ID so as to correspond to the content URI and transmits the determined trigger ID to the trigger-element registry server 62. The trigger-element registry server 62 transits the received trigger ID and a trigger element corresponding thereto to the application server 12.

The application server 12 retrieves an action element having the same content as the received trigger element from the action-element DBs 44 to 46 and stores the received trigger ID so as to correspond to the action element. When the application server 12 receives an action message from the application client 11, the application server 12 detects an action element and the user ID a user who performed the action and retrieves a trigger ID corresponding to the action element from the action-element DBs 44 to 46. The application server 12 then transmits the trigger ID and the user ID to a trigger manager 64.

The trigger manager 64 receives the user ID and the trigger ID. The trigger manager 64 searches for the address of a content receiver corresponding to the received user ID from a user-address DB 63. The trigger manager 64 also searches for a content URI corresponding to the trigger ID from the trigger-element DB 65. The trigger manager 64 transmits the found content receiver's address and the content URI to a content sender 82.

In accordance with the received content-receiver's address, the content sender 82 transmits content corresponding to the received content URI to the content receiver 15.

While the network 10 is not shown in FIG. 2, information is communicated between the individual units over the network 10.

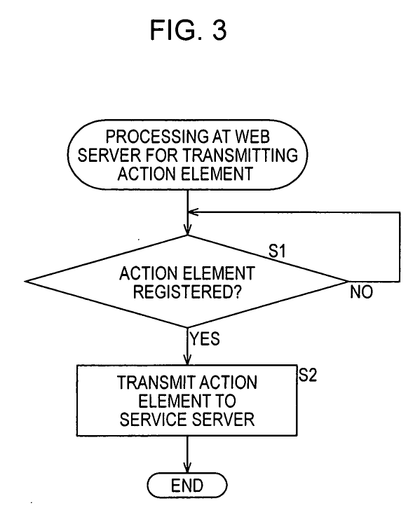

Next, processing in which the web server 41 transmits an action element from the action-element DB 44 to the action-element DB 61 of the service server 13 and issues a request for registering the action element will be described with reference to the flow chart shown in FIG. 3.

In step S1, the web server 41 determines whether or not an action element is registered in the action-element DB 44. When it is determined that no action element is registered in the action-element DB 44, the web server 41 waits until an action element is registered.

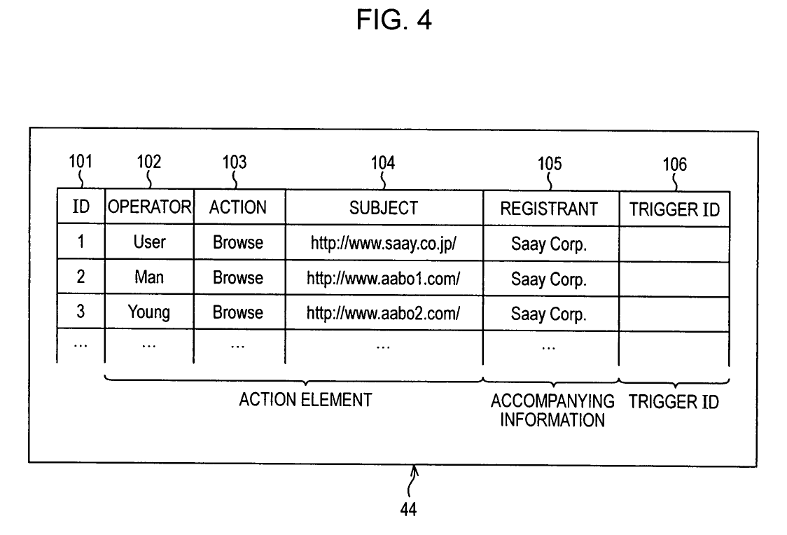

A provider who intends to provide a service for the web browser 31 registers an action into the action-element DB 44. FIG. 4 shows an example in which actions are registered in the action-element DB 44. In the action-element DB 44, action element IDs 101, action elements, action-element registrants 105 as accompanying information accompanying the action elements, and trigger IDs 106 are registered. Each action 103 is registered as an action element together with an operator 102 and a subject 104.

For example, an action with an action-element ID 101 of “1” is browsing “Browse,” performed by operator “User,” for “http://www.saay.co.jp/” registered by “Saay Corp.” Similarly, an action having an ID 101 of “2” is browsing “Browse,” performed by operator “Man,” for “http://www.aabo1.com/” registered by “Saay Corp.,” and an action having an ID 101 of “3” is browsing “Browse,” performed by operator “Young,” for “http://www.aabo2.com/” registered by “Saay Corp.”

In this manner, as a registrant, a content provider who wishes to ensure that content suitable for each general user is supplied to the user pre-registers, as action elements, user's actions that the provider wants to associate with the content. Once an action element is registered, when a user (the web browser 31) performs a predetermined action and the user's action corresponds to a registered action element, content is automatically registered in the user's content receiver 15.

In the case of the example shown in FIG. 4, when a general user (the user indicated by an operator 102 of “User”) browses “http://www.saany.co.jp/” specified as the subject 104 (i.e., performs a “Browse” action specified as the action 103), content specified by a trigger ID is supplied to the content receiver 15 of the user who performed the action. When a male user (a user indicated by an operator 102 of “Man”) browses “http://www.aabo1.com/” specified as the subject 104 (i.e., performs a “Browse” action specified as the action 103), content specified by a trigger ID is supplied to the content receiver 15 of the user who performed the action. Further, when a young user (a user indicated by an operator 102 of “Young”) browses “http://www.aabo2.com/” specified as the subject 104 (i.e., performs a “Browse” action specified as the action 103), content specified by a trigger ID is supplied to the content receiver 15 of the user who performed the action.

When it is determined in step S1 that an action element is registered, in step S2, the web server 41 transmits the registered action element to the action-element DB 61 of the service server 13, issues a request for registration, and ends the processing.

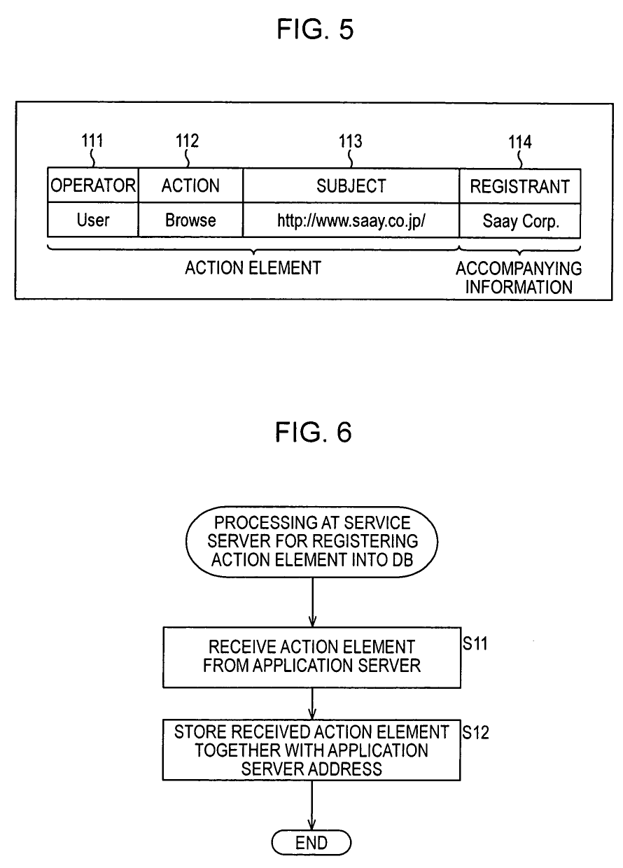

FIG. 5 shows an example of the action element transmitted to the action-element DB 61. The action element is constituted by an operator 111, an action 112, and a subject 113. A registrant 114 who has registered the action element is also transmitted as accompanying information of the action element.

In the case of the example shown in FIG. 5, the action of browsing “http://www.saay.co.jp/” registered by “Saay Corp.” is transmitted to the action-element DB 61. That is, FIG. 5 shows an example when the action element with ID “1” shown in FIG. 4 is transmitted.

Processing in which the service server 13 registers the action element into the action-element DB 61 in response to the processing of the web server 41 which is shown in the flow chart of FIG. 3 will now be described with reference to the flow chart shown in FIG. 6.

In step S11, the service server 13 receives an action element as shown in FIG. 5 from the web server 41. In step S12, the service server 13 stores the received action element, together with the address of the web server 41 (the application server 12), into the action-element DB 61.

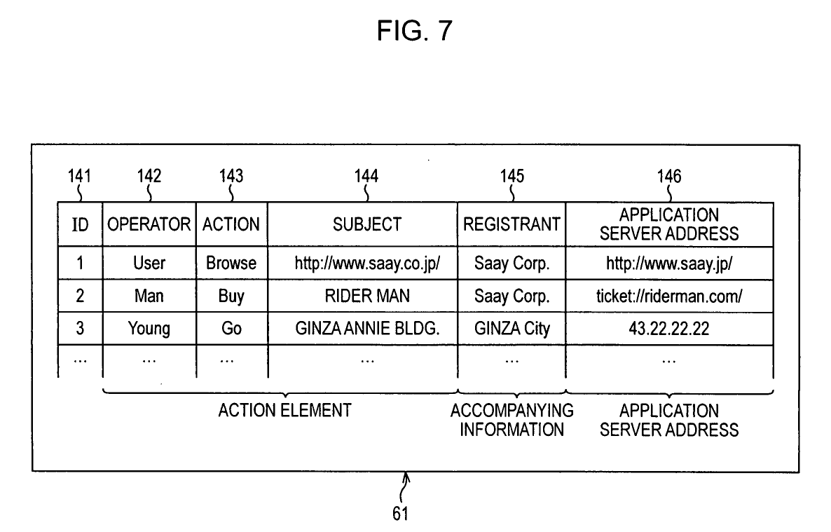

Registration processing as described above is repeated, so that received action elements are registered, as shown in FIG. 7, in the action-element DB 61. In the action-element DB 61, action element IDs 141, action elements received from the web server 41, registrants 145 as accompanying information of the action elements, and application-server addresses 164 are registered. Each action element is constituted by an operator 142, an action 143, and a subject 144. The application-server address 146 is an address for identifying a position in terms of a network and is, for example, the IP address of the web server 41 (the application server 12) for which the action element is registered.

In the example shown in FIG. 7, an action having an ID 141 of “1” is browsing of “http://www.saay.co.jp/” registered by “Saay Corp.” and the address of the application server 12 from which the action can be obtained is “http://www.saay.jp/.” Similarly, an action having an ID 141 of “2” is purchasing (Buy) of “Rider Man” registered by “Saay Corp.” and the address of the application server 12 from which the action can be obtained is “ticket://riderman.com.” An action having an ID 141 of “3” is knowing how to go (Go) to “Ginza Annie Building” registered by “GINZA City” and the address of the application server 12 from which the action is obtained is “43.22.22.22.” The operators 142 are “User,” “Man,” and “Young,” respectively.

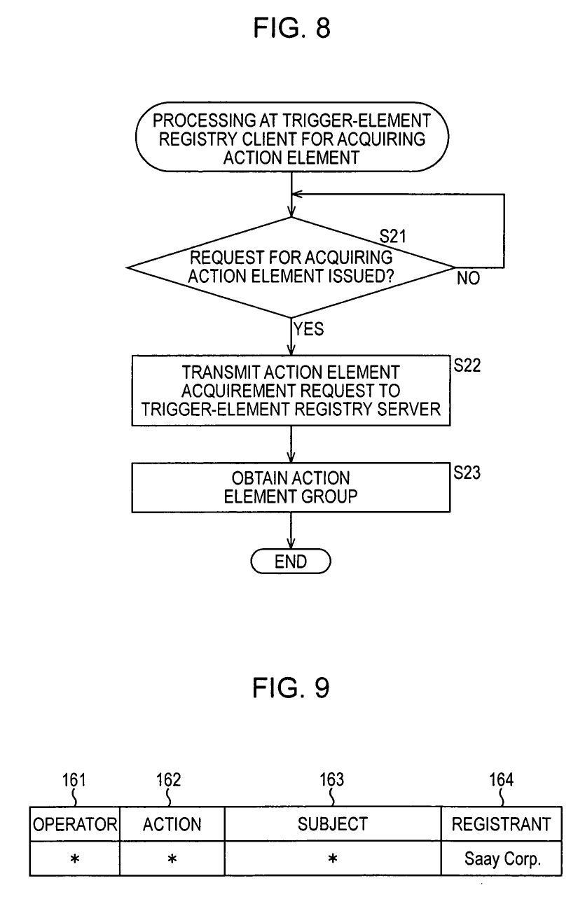

Next, processing in which the trigger-element registry client 81 acquires an action element stored in the action-element DB 61 will be described with reference to the flow chart show in FIG. 8.

In step S21, the trigger-element registry client 81 determines whether or not a request for acquiring an action element is issued from the administrator of the content server 14. When it is determined that a request for acquiring an action element is not issued from a user, the trigger-element registry client 81 waits until a request for acquiring an action element is issued.

When it is determined in step S21 that a request for acquiring an action element is issued from the administrator, the trigger-element registry client 81 advances the process to step S22, in which the trigger-element registry client 81 transmits an action-element acquirement request to the trigger-element registry server 62.

FIG. 9 shows an example of the action-element acquirement requesting message transmitted from the trigger-element registry client 81. The message is constituted by an operator 161, an action 162, a subject 163, and a registrant 164. Also, “*” indicates a wildcard. That is, in the case of the example shown in FIG. 9, the trigger-element registry client 81 issues an request for acquiring an action element with a registrant 164 of “Saay Corp.”

In step S23, the trigger-element registry client 81 acquires an action element group from the trigger-element registry server 62, registers the action element group, and ends the processing.

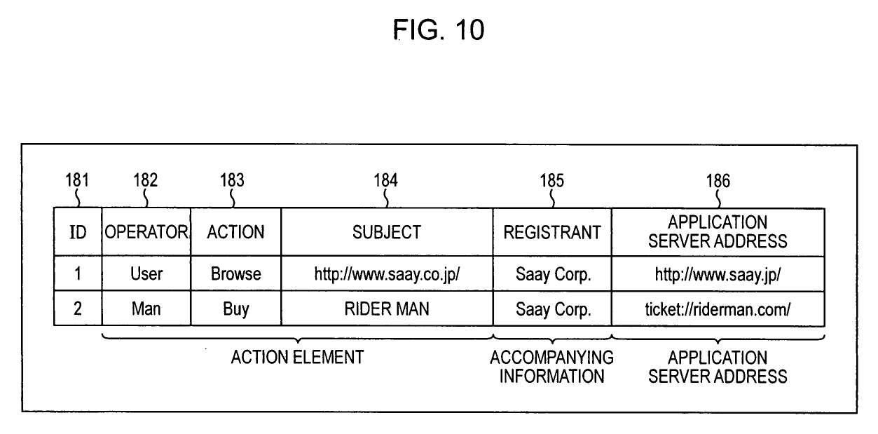

As shown in FIG. 7, action elements are stored in the action-element DB 61. When an action-element acquirement requesting message as shown in FIG. 9 is received, the trigger-element registry client 81 acquires an action element group as shown in FIG. 10.

The action element group is constituted by action elements IDs 181, action elements, registrants 185 as accompanying information of the action elements, and application-server addresses 186. Each action element is constituted by an operator 182, an action 183, and a subject 184.

Out of the action element group shown in FIG. 7, action elements with a registrant of “Saay Corp.” have IDs 141 of “1” and “2.” Thus, the action element group acquired by the trigger-element registry client 81 is constituted by actions having IDs 181 of “1” and “2” as shown in FIG. 10.

Thus, for the action having an ID 181 of “1,” the operator 182 is “User,” the action 183 is “Browser,” the subject 184 is “http://www.saay.co.jp/,” the registrant 185 is “Saay Corp.,” and the application-server address is “http://www.saay.jp/.” For the action having an ID 181 of “2,” the operator 182 is “Man,” the action 183 is “Buy,” the subject 184 is “Rider Man,” the registrant 185 is “Saay Corp.,” and the application-server address 186 is “ticket://riderman.com.”

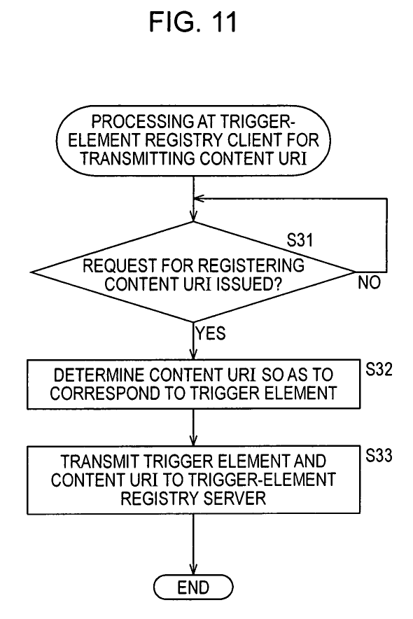

The administrator of the content server 14 who intends to supply content to the user of the application client 11 needs to pre-register a content URI (Uniform Resource Indicator) into the service server 13 as necessary information for the user to access the content. Next, processing in which the trigger-element registry client 81 transmits a content URI to the service server 13 for registration will be described with reference to the flow chart show in FIG. 11.

In step S31, the trigger-element registry client 81 of the content server 14 determines whether or not a request for registering a content URI is issued from the administrator of the content server 14. When it is determined that a request for registering a content URI is not issued from a user, the trigger-element registry client 81 waits until a request for registering a content URI is issued.

When it is determined in step S31 that a request for registering a content URI is issued from the administrator, the trigger-element registry client 81 determines a content URI so as to correspond to an action element (specified to be registered, and this action element hereinafter will be called a trigger element) selected by the administrator from the action element group received from the trigger-element registry server 62 in the processing in step S23 of FIG. 8 and registered.

In step S33, the trigger-element registry client 81 transmits a request for registering the trigger element and the content URI to the trigger-element registry server 62, and ends the processing.

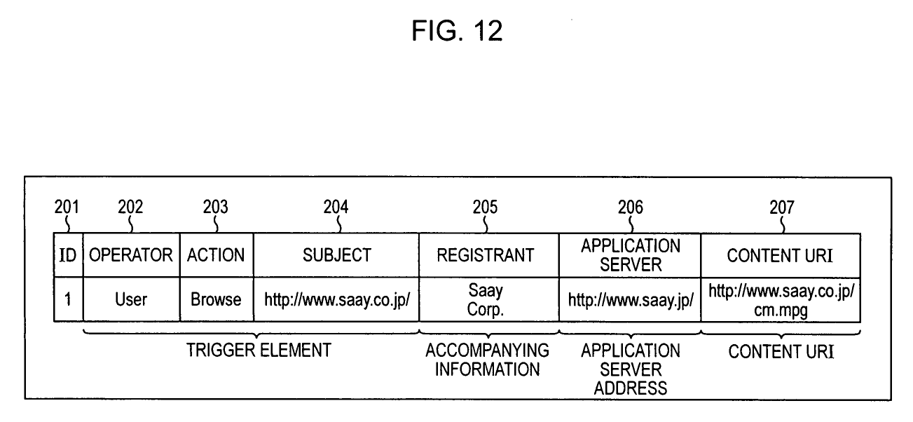

FIG. 12 shows an example of the trigger element and the content URI which are contained in the registration requesting message transmitted from the trigger-element registry client 81 to the trigger-element registry server 62. The message transmitted from the trigger-element registry client 81 contains a trigger element ID 201, a trigger element, a registrant 205 accompanying information accompanying the trigger element, an application-server address 206, and a content URI 207 determined so as to correspond to the trigger element. The trigger element is constituted by an operator 202, an action 203, and a subject 204.

For example, for a trigger element having an ID 201 of “1,” “http://www.saay.co.jp/cm.mpg” is set as the content URI 207. That is, the content URI of content that corresponds to browsing of “http.saay.co.jp” registered by “Saay Corp.” and that is requested to the application server 12 (the web server 41) having an application-server address 206 of “http://www.saay.co.jp/” is “http://www.saay.co.jp/cm.mpg.”

In this manner, the administrator of the content server 14 who intends to supply content can register the content, he/she wants to supply, for an action. Also, the administrator of the content server 14 can readily update the registration of the content.

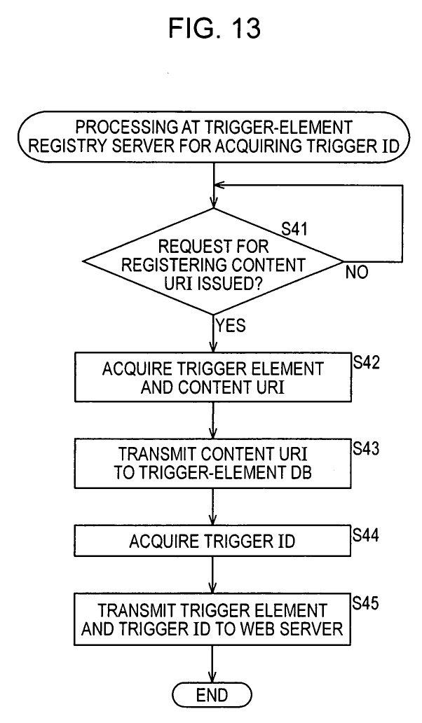

Processing in which the trigger-element registry server 62 acquires a trigger ID in response to the processing of the trigger-element registry client 81 which is shown in the flow chart in FIG. 11 will now be described with reference to the flow chart shown in FIG. 13.

Although one content URI is determined for one trigger element in the above-described processing, one content URI may be determined for a number of trigger elements. A number of content URIs also may be determined for one trigger element.

In step S41, the trigger-element registry server 62 determines whether or not a request for registering a trigger element and a content URI is issued from the trigger-element registry client 81. When it is determined that a request for registering a trigger element and a content URI is not issued from the trigger-element registry client 81, the trigger-element registry server 62 waits until a request for registering a trigger element and a content URI is issued.

When the request is received, in step S42, the trigger-element registry server 62 acquires a trigger element and a content URI corresponding thereto as shown in FIG. 12, the trigger element and the content URI being contained in the message received from the trigger-element registry client 81.

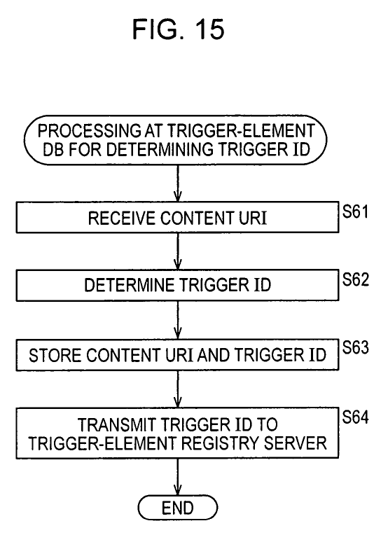

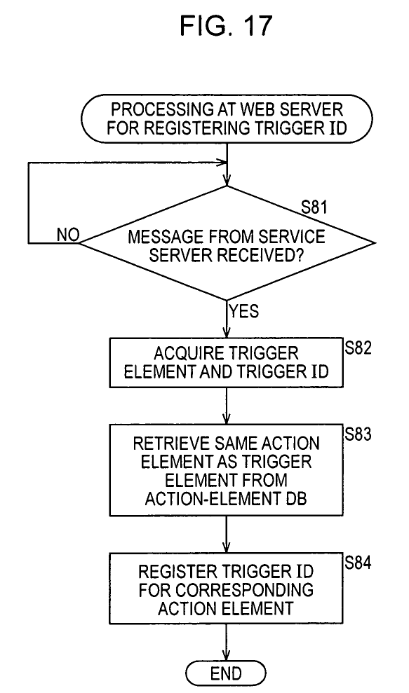

In step S43, the trigger-element registry server 62 transmits the content URI acquired in the processing in step S42 to the trigger-element DB 65. As will be described below, upon receiving the content URI, the trigger-element DB 65 determines a trigger ID corresponding to the content URI (in step S62 shown in FIG. 15 and described below) and transmits the trigger ID (in step S64 in FIG. 15). Thus, in step S44, the trigger-element registry server 62 acquires the trigger ID, corresponding to the content URI, transmitted from the trigger-element DB 65. In step S45, the trigger-element registry server 62 transmits the trigger element and the trigger ID to the web server 41 and ends the processing. The trigger element and the trigger ID are received by the web server 41 in step S82 shown in FIG. 17 and described below.

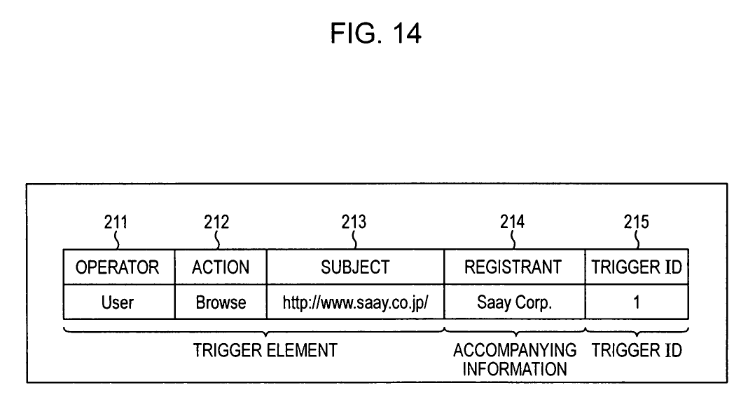

FIG. 14 shows an example of the trigger element and the trigger ID which are transmitted from the trigger-element registry server 62 to the web server 41.

The message transmitted to the web server 41 is constituted by a trigger element, a registrant 214 as accompanying information accompanying the trigger element, and a trigger ID 215. The trigger element is constituted by an operator 211, an action 212, and a subject 213.

In the case of the example shown in FIG. 14, the trigger ID 215 is set to “1” for the trigger element corresponding to the action of browsing “http://www.saay.co.jp/” registered by “Saay Corp.”

Next, processing executed by the trigger element DB 65 to determine a trigger ID in response to the processing in which the trigger-element registry server 62 transmits the content URI in step S43 of FIG. 13 will be described with reference to the flow chart shown in FIG. 15.

In step S61, the trigger element DB 65 receives the content URI that trigger-element registry server 62 has transmitted in the processing in step S43 of FIG. 13. In step S62, the trigger element DB 65 determines a trigger ID corresponding to the content URI received in the processing in step S61. In step S63, the trigger element DB 65 stores the determined trigger ID and the content URI. In step S64, the trigger element DB 65 transmits the trigger ID determined in the processing in step S62 to the trigger-element registry server 62. The trigger ID is received by the trigger-element registry server 62 in step S44 of FIG. 13.

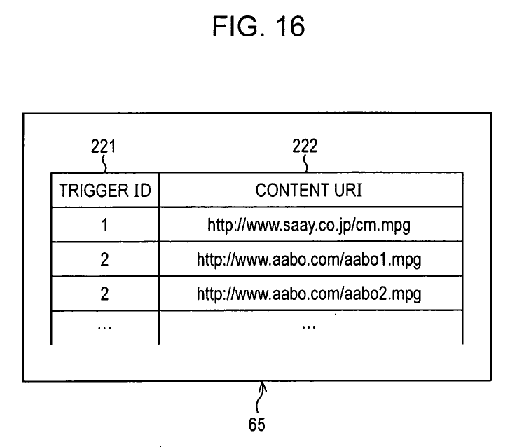

FIG. 16 shows an example of data stored in the trigger element DB 65. Each piece of data is constituted by a trigger ID 221 and a content URI 222.

In this case, for example, the content URI 222 with a trigger ID 221 of “1” is “http://www.saay.co.jp/cm.mpg.” The trigger IDs 221 for content URIs 222 of “http://www.aabo.com/aabo1.mpg” and “http://www.aabo.com/aabo2.mpg” are “2.” In this manner, even when a number of content URIs are determined for one trigger element, one trigger ID is determined for one trigger element (a number of content URIs).

Next, processing executed by the web server 41 to register a trigger ID into the action-element DB 44 in response to the transmission processing of the trigger-element registry server 62 which is shown in step S45 of FIG. 13 will be described in detail with reference to the flow chart shown in FIG. 17.

In step S81, the web server 41 determines whether or not the message that is transmitted from the trigger-element registry server 62 in the processing in step S45 of FIG. 13 and contains the trigger element and the trigger ID is received. When it is determined that the message from the trigger-element registry server 62 is not received, the web server 41 waits until the message from the service server 13 is received.

When it is determined in step S81 that the message from the trigger-element registry server 62 is received, the web server 41 advances the process to step S82, in which the web server 41 acquires the trigger element and the trigger ID from the message from the trigger-element registry server 62. In step S83, the web server 41 retrieves the same action element as the trigger element acquired in the processing in step S82 from the action-element DB 44.

As described above, the trigger element (FIG. 12) is specified for registration, out of the action elements (FIG. 4) transmitted from the web server 41 to the action element DB 61 in the processing in step S2 shown in FIG. 3. Thus, the action element corresponding to the trigger element is held by the action-element DB 44.

In step S84, the web server 41 registers a trigger ID (FIG. 14), associated with the trigger element, for the action element that is retrieved in the processing in step S83 that is associated with the trigger element, out of the action elements shown in FIG. 4. The web server 41 then ends the processing.

Processing as described above is repeated, so that the state of the action-element DB 44 in which the trigger IDs are registered changes from FIG. 4 to FIG. 18. For example, when the message shown in FIG. 14 is transmitted from the trigger-element registry server 62, “1” is registered as the trigger ID 106 so as to correspond to the action element (the operator 102 is “User,” the action 103 is “Browse,” and the subject 104 is “http://www.saay.co.jp/”) with an ID 101 of “1” in which the same contents as the received trigger element (the operator 211 is “User,” the action 212 is “Browse,” and the subject 213 is “http://www.saay.co.jp/”) are stored.

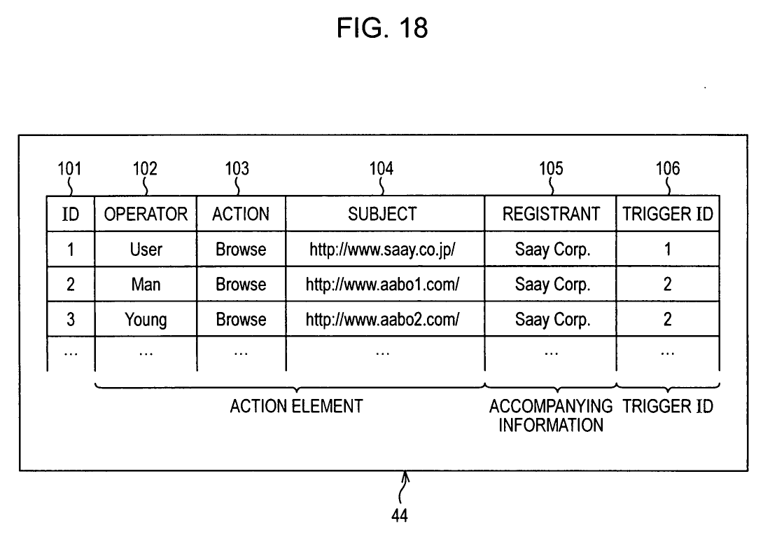

Similarly, when a trigger element and a trigger element ID “2” which have the same content as the actions elements with IDs 101 of “2” and “3” are received from the trigger-element registry server 62, “2” is registered as the trigger ID 106 so as to correspond to the action elements with IDs 101 of “2” and “3,” as shown in FIG. 18.

As described above, when the trigger ID(s) are registered in the action-element DB 44, the web server 41 can provide content corresponding to browser processing of the web browser 31 that serves as a general user (the application client 11).

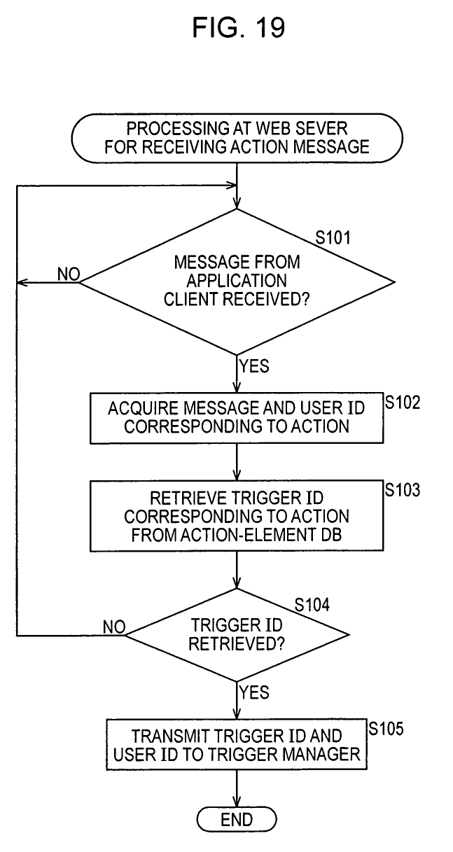

Next, processing in which a general user executes predetermined browser processing at the web browser 31 will be described with reference to the flow chart shown in FIG. 19.

In step S101, the web server 41 determines whether or not a message from the web browser 31 (the application client 11) is received. When it is determined that a message from the web browser 31 is not received, the web server 41 waits until a message from the web browser 31 is received.

When it is determined in step S101 that a message from the web browser 31 is received, the web server 41 advances the process to step S102, in which the web server 41 acquires a message (an action message) and a user ID which correspond to the action from the received message. The action message contains, for example, the HTTP (Hyper Text Transfer Protocol) based URL (the subject 104 included in the action element shown in FIG. 4) of a homepage that the user wishes to browse.

Further, since the action is access to the homepage from the web browser 31, the web server 41 recognizes that the action 103 is “Browse.” In accordance with the user ID, the web server 41 also identifies which one of the operators 102 (i.e., “User,” “Man,” “Young,” and so on) the user is. For this purpose, the web server 41 holds user information needed to determine to which of the operators 102 each user corresponds. Alternatively, information representing the operator 102 and the action 103 which are shown in FIG. 4 may be transmitted from the web browser 31 to the web server 41.

In step S103, the web server 41 retrieves a trigger ID corresponding to the action in the action message from the action-element DB 44. For example, when data as shown in FIG. 18 are stored in the action-element DB 44, trigger ID “1” is retrieved in response to a request for browsing “http://www.saay.co.jp/.”

In step S104, the web server 41 determines whether or not a trigger ID is retrieved from the action-element DB 44. When it is determined that a trigger ID is not retrieved from the action-element DB 44, the web server 41 returns the process to step S101. That is, in this case, the web server 41 cannot execute processing corresponding to the request from the web browser 31 and, thus, does not execute special processing.

When it is determined in step S1104 that a trigger ID is retrieved from the action-element DB 44, the web server 41 advances the process to step S105, in which the web server 41 transmits the retrieved trigger ID and the received user ID to the trigger manager 64, and then ends the processing.

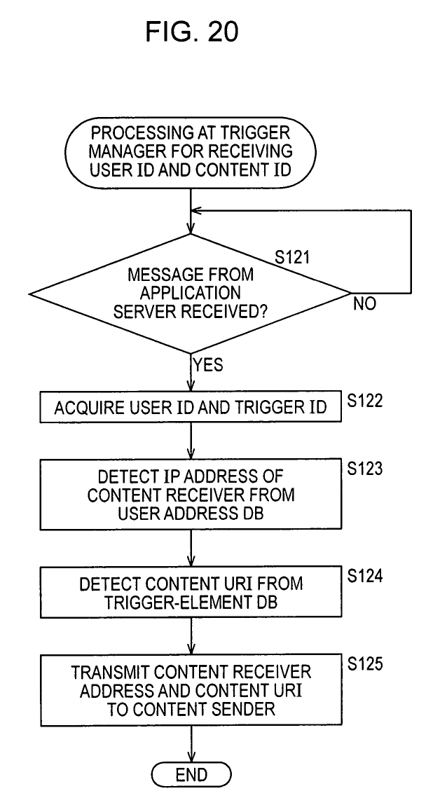

Processing executed by the trigger manager 64 in response to the processing in which the web server 41 transmits the user ID and the trigger ID will now be described with reference to the flow chart shown in FIG. 20.

In step S121, the trigger manager 64 determines whether or not a message is received from the web server 41. When it is determined that a message from the web server 41 is not received, the trigger manager 64 waits until a message from the web server 41 is received.

In step S121, when it is determined that a message from the web server 41 is received, the trigger manager 64 advances the process to step S122, in which the web server 64 acquires the user ID and the trigger ID which are contained in the message received from the web server 41. In step S123, the trigger manager 64 detects the IP address of a content receiver corresponding to the user ID from the user-address DB 63.

The user who uses a service provided by the web server 41 registers his/her identity into the web server 41 in advance. When a request for user registration is issued from the web browser 31, the web server 41 issues a request for the registration to the trigger manager 64. Upon receiving the registration request, the trigger manager 64 issues a user ID for the user and registers the user ID, together with user information, into the user-address DB 63. When the content receiver 15 is contained in the user information input from the user, the trigger manager 64 assigns an IP address to the content receiver 15 and registers the IP address into the user-address DB 63.

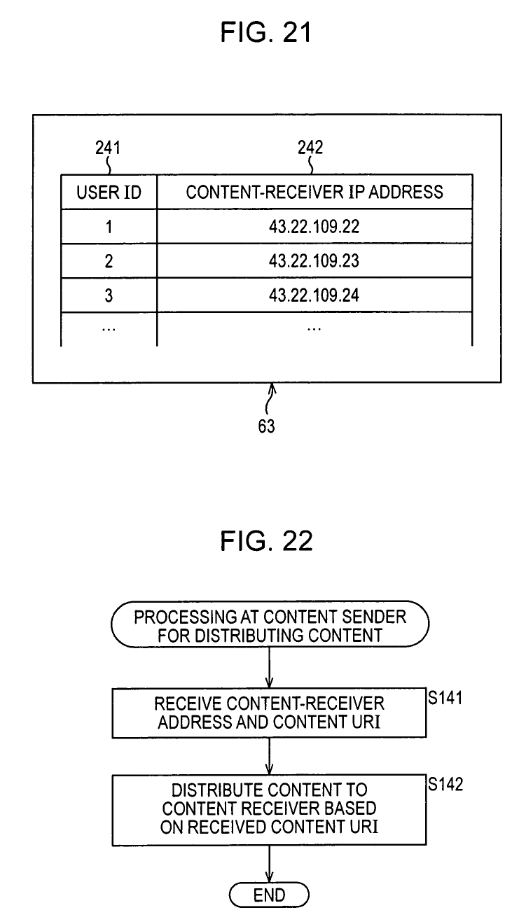

FIG. 21 shows examples of data stored in the user-address DB 63. Each piece of data is constituted by a user ID 241 and a content-receiver IP address 242. In the case of the examples shown in FIG. 21, the IP address 242 of a content receiver 15 corresponding to a user with a user ID 241 of “1” is “43.22.109.22.” Similarly, the IP address 242 of a content receiver 15 corresponding to a user with a user ID 241 of “2” is “43.22.109.23” and the IP address 242 of a content receiver 15 corresponding to a user with a user ID 241 of “3” is “43.22.109.24.”

In step S124, the trigger manager 64 detects a content URI corresponding to the trigger ID acquired in step S122 from the trigger element DB 65 (FIG. 16). For example, when the received trigger ID is “1,” the trigger manager 64 detects “http://www.saay.co.jp/cm.mpg” as the content URI, as shown in FIG. 16.

In step S125, the trigger manager 64 transmits the content-receiver address detected in step S123 and the content URI detected in step S124 to the content sender 82, and ends the processing. For example, when both of the received user ID (FIG. 21) and the trigger ID (FIG. 16) are “1,” “43.22.109.22” as the IP address of the content receiver 15 and “http://www.saay.co.jp/cm.mpg” as the content URI are transmitted to the content sender 82.

Processing in which the content sender 82 distributes content to the content receiver 15 in response to the processing of the trigger manager 64 which is shown in the flow chart of FIG. 20 now will be described with reference to the flow chart shown in FIG. 22.

In step S141, the content sender 82 receives the content-receiver address and the content URI which are transmitted by the trigger manager 64 in the processing in step S125 of FIG. 20. In step S142, in accordance with the received content URI, the content sender 82 acquires content that is internally stored and distributes the content to the content receiver 15 indicated by the received content-receiver address.

For example, when the IP address of the received content receiver 15 is “43.22.109.22” and the content URI is “http://www.saay.co.jp/cm.mpg,” the content of the URI “http://www.saay.co.jp/cm.mpg” is distributed to the content receiver 15 having an IP address of “43.22.109.22.”

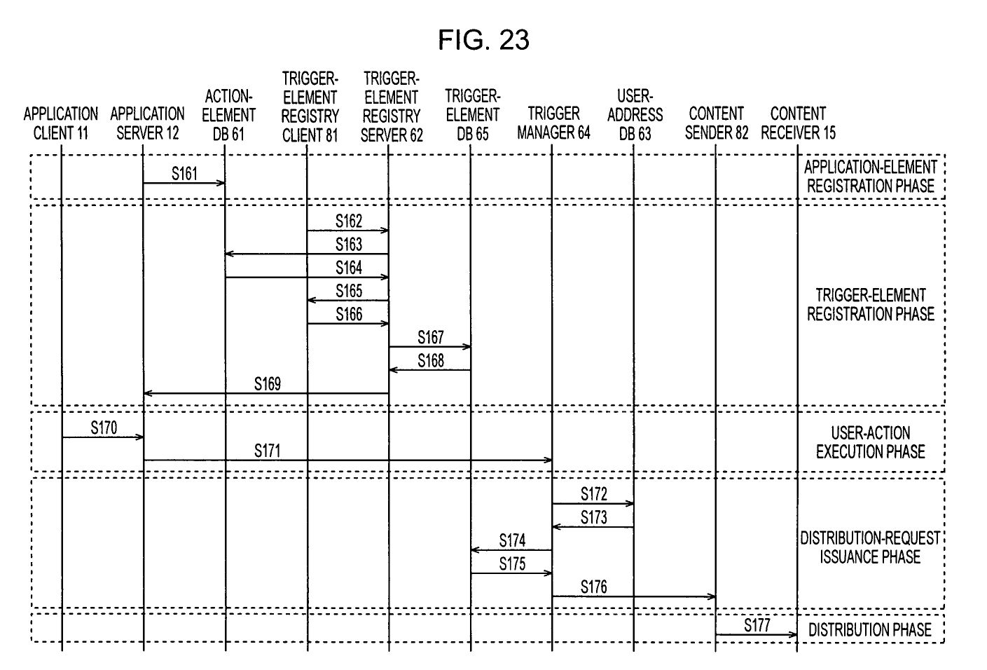

While processes of the individual units are separately described above, the operation of the entire system can be summarized as shown in FIG. 23. In step S161, the application server 12 (the web server 41) transmits an action element of an action that can be processed by the application server 12 to the action element DB 61 of the service server 13 and causes the action element to be registered. This processing is action-element registration phase processing.

In step S162, the trigger-element registry client 81 issues a request for acquiring an action element group to the trigger-element registry server 62. In step S163, the trigger-element registry server 62 issues a request for acquiring the action element group to the action element DB 61. In step S164, the action element DB 61 transmits the requested action element group to the trigger-element registry server 62. In step S165, the trigger-element registry server 62 transmits the received action element group to the trigger-element registry client 81.

In step S166, the trigger-element registry client 81 selects an action element and transmits the selected action element (a trigger element) and a content URI corresponding to the trigger element to the trigger-element registry server 62. In step S167, the trigger-element registry server 62 registers the received content URI into the trigger element DB 65. In step S168, the trigger element DB 65 determines a trigger ID for the registered content URI and transmits the determined trigger ID to the trigger-element registry server 62.

In step S169, the trigger-element registry server 62 transmits the trigger element and the trigger ID to the application server 12 (the web server 41) and causes the trigger ID to be registered. The above processing is a trigger-element registration phase, in which the registration of the trigger element (the action element) is completed and content can be supplied in this state.

In step S170, when an action is performed, the application client 11 (the web browser 31) transmits the ID of a user who performed the action and an action message corresponding to the action to the application server 12 (the web server 41). In step S171, the application server 12 transmits the user ID and a trigger ID corresponding to the action in the action message to the trigger manager 64. The above processing is a phase for executing processing corresponding to a user action.

In step S172, the trigger manager 64 transmits the received user ID to the user-address DB 63. In step S173, the user-address DB 63 transmits the address of a content receiver corresponding to the received user ID to the trigger manager 64.

In step S174, the trigger manager 64 transmits the received user ID to the trigger element DB 65. In step S175, the trigger element DB 65 transmits a content URI corresponding to the received trigger ID to the trigger manager 64.

In step S176, the trigger manager 64 transmits the received content-receiver address and the content URI to the content sender 82. The above is a phase for issuing a content distribution request.

In step S177, in accordance with the received content-receiver address and the content URI, the content sender 82 distributes content to the content receiver 15. The above processing is a distribution phase.

As described, when a user executes an action, such as browsing a predetermined home page, using the web browser 31, and the action corresponds to an action element registered in the action-element DB 44, content associated with the action element (the trigger element) is automatically registered into the content receiver 15 without the user's instruction. The user accesses the content receiver 15, as needed, and listens to and/or views the registered content.

The content is provided based on the user's actual action and thus meets the user's preference. As such, the user can readily obtain content that meets his/her preference without entering preference information on his/her own. In addition, even if the preference changes, the user can obtain content that meets the latest own preference without being requested to perform a special operation.

The provider of the content can ensure that the user to whom the provider supplies the content can listen to and/or view the content, and thus can efficiently distribute content. Also, the provider can readily change content to be supplied.

The administrator of the application server 12 or the service server 13 can also charge fees to the administrator (the content provider) of the content server 14 to make a profit.

A description now will be given in terms of individual servers constituting the system. The service server 13 holds a content URI from the content server 14 and performs interface processing, such as transmission to the application server 12, between many content servers 14 and many application servers 12. Thus, without putting a large load on each application server 12 or each content server 14, such arrangement can facilitate and ensure that content corresponding to an actual action of the user of the application server 12 is supplied to the user of the application server 12.

That is, this arrangement can facilitate and ensure that content which meets the user's preference is supplied to the application client 11, without the application server 12 directly contracting with many content servers 14 or preparing large-scale equipment. Further, conversely, this arrangement also may facilitate and ensure that content which meets the preference of each of a large number of users is supplied thereto, without the content server 14 directly contracting with many content servers 12 or preparing large-scale equipment.

The content server 14 associates a content URI with an action processable by the application server 12, transmits the content URI to the service server 13, and causes the service server 13 to perform registration. Upon receiving the content URI and the address of a device with which the action was performed from the service server 13, content is transmitted to the address. Thus, a content URI to be associated with an action can be arbitrarily set, content to be supplied and a user to which the content is supplied can be selected. Content can be easily and reliably supplied to a user to whom the provider wishes to supply the content.

The application server 12 holds trigger IDs and actions and retrieves a trigger ID corresponding to an action input from the application client 11, transmits the retrieved trigger ID and the address of a device that performed the input action to the service server 13, and further causes the trigger ID and the address to be transferred to the content server 14. Thus, without putting a load on the user of the application client 11, this arrangement can supply content suitable for the user, in addition to offering the original action-related service. That is, it is possible to offer more-value-added services to users.

The content herein includes still images, moving images, sound, text, and other information.

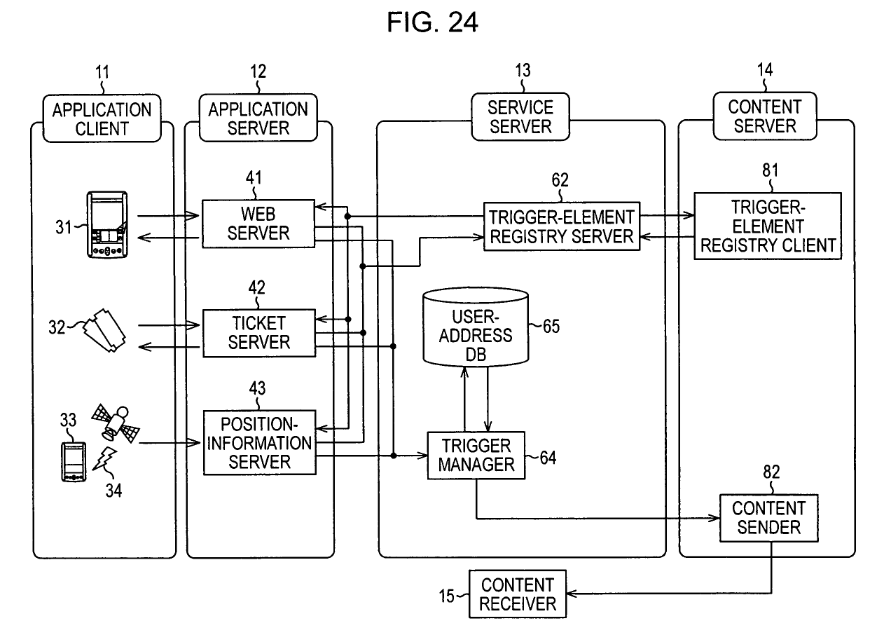

FIG. 24 shows another embodiment of the information distribution system according to the present invention. In this example, the application server 12 holds a content URI corresponding to an action. Thus, there is no need to provide the action elements DBs 44 to 46 and the action element DB 61 and the trigger element DB 65 of the web browser 31 shown in FIG. 2.

Thus, when the trigger-element registry client 81 issues a request for acquiring an action element group, the action element group is transmitted from the application server 12 to the trigger-element registry client 81 via the trigger-element registry server 62. The trigger-element registry client 81 selects an action element, transmits the selected action element (a trigger element) and a content URI corresponding to the trigger element to the application server 12 via the trigger-element registry server 62 and causes the trigger element and the content URI to be registered.

Upon receiving an action from a user, the application server 12 transmits a user ID and a content URI to the trigger manager 64, and the content sender 82 distributes content to the content receiver 15.

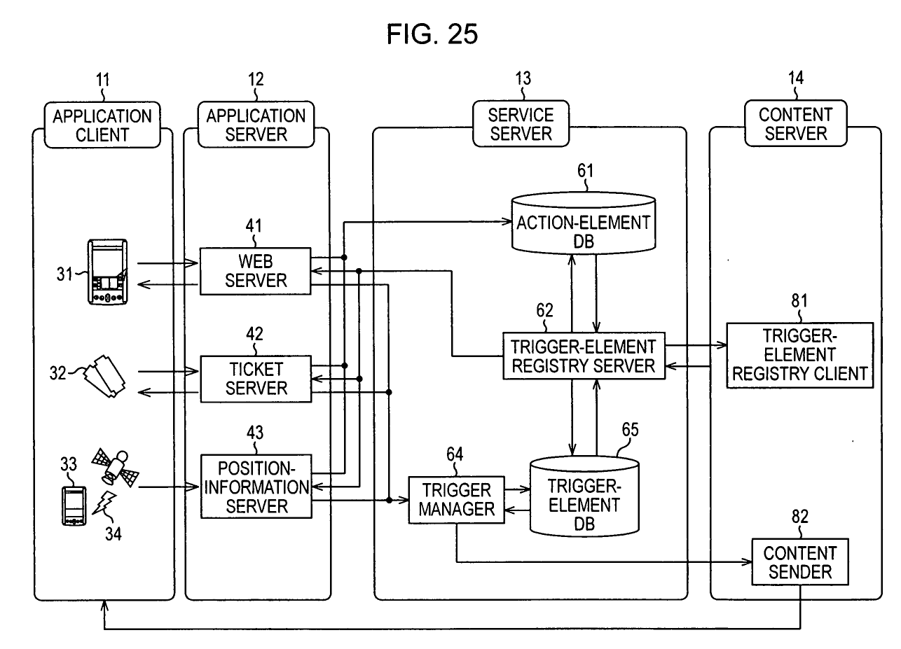

FIG. 25 shows still another embodiment of the information distribution system according to the present invention. In this example, content is supplied to a terminal provided with the application client 11. Thus, there is no need to provide the user-address DB 63 and the content receiver 15.

That is, the application server 12 transmits the address of the terminal, instead of the user ID, to the trigger manager 64 and the content server 14 causes content to be supplied to the terminal.

In the processing described above, the web server 41 transmits action elements registered in the action-element DB 44. In the same manner, the ticket server 42 and the position-information server 43 transmit action elements registered in the respective action element DBs 45 and 46.

Additionally, with regard to the application server 12, the service server 13, and the content server 14, two or more such servers may be contained in one server.

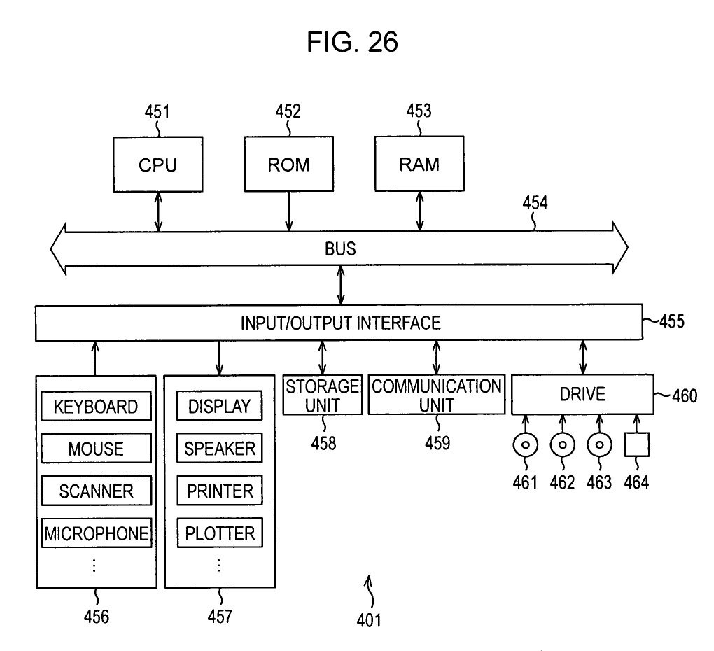

The series of processing described above can be executed by hardware or software. In this case, for example, the content server 14 is implemented by a computer 401 as shown in FIG. 26.

The computer 401 shown in FIG. 26 includes a CPU (Central Processing Unit) 451. The CPU 451 is connected to an input/output interface 455 via a bus 454. A ROM (Read Only Memory) 452 and a RAM (Random Access Memory) 453 are connected to the bus 454.

An operation input section 456 and an output section 457 are connected to the input/output interface 455. The operation input section 456 is constituted by input devices, such as a keyboard, a mouse, and a microphone which are operated by a user. The output section 457 is constituted by output devices, such as a display, a speaker, a printer, and a plotter. Also connected to the input/output interface 455 are a storage unit 458, which includes a hard disk drive or the like for storing a program and various types of data, and a communication unit 459, which communicates data over the network 10 including the Internet.

Further, a drive 460 is connected to the input/output interface 455, as needed, to write/read data to/from storage media, such as a magnetic disk 461, an optical disk 462, a magneto-optical disk 463, and a semiconductor memory 464.

An information processing program for causing the computer 401 to execute operation as a content server according to the present invention is stored in the magnetic disk 461 (including a floppy disk), the optical disk 462 (including a CD-ROM (compact disk-read only memory) and a DVD (Digital Versatile Disk)), a magneto-optical disk 463 (including an MD (Mini Disc)), or a semiconductor memory 464, is supplied to the computer 401, is read by the drive 460, and is installed onto a hard disk drive built into the storage unit 458. The information processing program installed on the storage unit 458 is loaded from the storage unit 458 to the RAM 453 in response to an instruction from the CPU 451 which corresponds to a command input by a user at the input section 456.

When the series of processing is executed by software, a program for implementing the software is installed via a network or a storage medium on to a computer incorporated in to dedicated hardware or onto, for example, a general-purpose personal computer that can execute various functions through installation of various programs.

The program storage medium for recording the program may be a package medium that is distributed separately from a computer to supply a program to users. As shown in FIG. 26, examples of the package medium include the magnetic disk 461, the optical disk 462, the magneto-optical disk 463, and the semiconductor memory 464. The program storage medium also may be the ROM 452 or the hard disk included in the storage unit 458, the ROM 452 or the hard disk being pre-installed in a computer and being supplied to users.

Herein, the steps for describing the program recorded in such a storage medium may or may not be processed in a time series according to the sequence described above. Thus, those steps may be processed concurrently or individually.

### INDUSTRIAL APPLICABILITY

As described above, according to the present invention, content can be distributed. In particular, without putting a large amount of load on a user, the distribution can be facilitated. Also, the URI of content can be easily updated. Further, content that meets an action or preference of the user can be distributed. Also, content can be efficiently distributed. Additionally, it is possible to charge fees to a content provider to make a profit.

Although the present invention has been described with reference to specific embodiments, those of skill in the art will recognize that changes may be made thereto without departing from the spirit and scope of the present invention as set forth in the hereafter appended claims.

1-20. (canceled)

21. An information processing system, comprising a first information processing device for receiving access information for accessing content, a second information processing device for transmitting the access information to the first information processing device, and a third information processing device for detecting action information,
wherein the first information processing device comprises:
a first receiver for receiving the access information from the second information processing device;
a first holding part for holding the access information received by the first receiver; and
a first transmitter for transmitting the access information corresponding to action information to the third information processing device;
wherein the second information processing device comprises:
a first acquiring part for acquiring the action information processable by the third information processing device;
a second transmitter for transmitting the access information corresponding to the action information to the first information processing device;
a second receiver for receiving an address of a device with which an action was performed and the access information corresponding to the performed action from the third information processing device; and
a third transmitter for transmitting content to the address in accordance with the access information received by the second receiver; and
wherein the third information processing device comprises:
a third receiver for receiving the access information and the action information corresponding to the access information from the first information processing device;
a second holding part for holding the access information so as to correspond to the action information received by the third receiver;
a second acquiring part for acquiring the address of the device with which the action was performed, the action and the action information;
a retrieving part for retrieving the access information corresponding to the action information from the information held by the second holding part; and
a fourth transmitter for transmitting the address acquired by the second acquiring part and the access information retrieved by the retrieving part to the second information processing device.

22. An information processing method for an information processing system having a first information processing device for receiving access information for accessing content, a second information processing device for transmitting the access information to the first information processing device, and a third information processing device for detecting action information,
wherein the information processing method for the first information processing device comprises:
receiving the access information from the second information processing device;
holding the access information received in the processing of the step of receiving the access information received in the processing of the step of receiving the access information; and
transmitting action information corresponding to the access information to the third information processing device;
wherein the information processing method for the second information processing device comprises:
acquiring the action information processable by the third information processing device;
transmitting the access information corresponding to the action information to the first information processing device;
receiving an address of a device with which an action was performed and the access information corresponding to the performed action from the third information processing device; and
transmitting content to the address in accordance with the access information received in the processing of the step of receiving an address; and
wherein the information processing method for the third information processing device comprises:
receiving the access information and the action information corresponding to the access information from the first information processing device;
holding the access information so as to correspond to the action information received in the processing of the step of receiving the access information;
acquiring the address of the device with which the action was performed, the action and the action information;
retrieving the access information corresponding to the action information from the information held in the processing of the step of holding the access information; and
transmitting the address acquired in the processing of the step of acquiring the address and the access information retrieved in the processing of the step of receiving the access information to the second information processing device.

23. An information processing device, comprising:
a first receiver for receiving access information for accessing content from a first another information processing device;
a first holding part for holding the access information received by the first receiver; and
a first transmitter for transmitting action information corresponding to the access information to a second another information processing device.

24. The information processing device as claimed in claim 23, further comprising a determining part for determining an ID corresponding to the access information received by the first receiver, wherein the first holding part holds the access information and the ID.

25. The information processing device as claimed in claim 24, further comprising:
a second receiver for receiving an address of a device with which an action was performed and an ID corresponding to the action from the second another information processing device;
a detector for detecting the access information corresponding to the ID from the first holding part; and
a second transmitter for transmitting the address and the access information to the first another information processing device.

26. An information processing device according to claim 25, further comprising a third receiver for receiving an action processable by the second another information processing device from the second another information processing device; and
a second holding part for holding the action received by the third receiver.

27. An information processing device according to claim 26, further comprising:
a fourth receiver for receiving a request for acquiring the action from the first another information processing device; and
a third transmitter for transmitting the action held by the second holding part to the first another information processing device.

28. An information processing method for an information processing device that receives access information for accessing content from a first another information processing device, the method comprising:
receiving the access information from the first another information processing device;
holding the access information received in the processing of the step of receiving; and
transmitting action information corresponding to the access information to a second another information processing device.

29. A program storage medium in which a computer-readable program for an information processing device that receives access information for accessing content from a first another information processing device is stored, the program comprising:
a receiving step of receiving the access information from the first another information processing device;
a hold controlling step of controlling holding of the access information received in the processing of the receiving step; and
a transmitting step of transmitting action information corresponding to the access information to a second another information processing device.

30. A program for a computer that controls an information processing device for receiving access information for accessing content from a first another information processing device, the program causing the computer to execute:
a receiving step of receiving the access information from the first another information processing device;
a hold controlling step of controlling holding of the access information received in the processing of the receiving step; and
a transmitting step of transmitting action information corresponding to the access information to a second another information processing device.

31. An information processing device, comprising:
an acquiring part for acquiring action information processable by a first another information processing device;
a first transmitter for transmitting access information corresponding to the action information to a second another information processing device;
a receiver for receiving an address of a device with which an action was performed and the access information corresponding to the performed action from the first another information processing device; and
a second transmitter for transmitting content to the address in accordance with the access information received by the receiver.

32. An information processing method for an information processing device that transmits access information for accessing content to a first another information processing device, the method comprising:
acquiring action information processable by a second another information processing device;
transmitting the access information corresponding to the action information to the first another information processing device;
receiving an address of a device with which an action was performed and the access information corresponding to the performed action from the second another information processing device; and
transmitting content to the address in accordance with the access information received in the processing of the step of receiving.

33. A program storage medium in which a computer-readable program for an information processing device that transmits access information for accessing content to a first another information processing device is stored, the program comprising:
an acquiring step of acquiring action information processable by a second another information processing device;
a first transmitting step of transmitting the access information corresponding to the action information to the first another information processing device;
a receiving step of receiving an address of a device with which an action was performed and the access information corresponding to the performed action from the second another information processing device; and
a second transmitting step of transmitting content to the address in accordance with the access information received in the processing of the receiving step.

34. A program for a computer that controls an information processing device for transmitting access information for accessing content to a first another information processing device, the program causing the computer to execute:
an acquiring step of acquiring action information processable by a second another information processing device;
a first transmitting step of transmitting the access information corresponding to the action information to the first another information processing device;
a receiving step of receiving an address of a device with which an action was performed and the access information corresponding to the performed action from the second another information processing device; and
a second transmitting step of transmitting content to the address in accordance with the access information received in the processing of the receiving step.

35. An information processing device, comprising:
a first receiver for receiving access information and action information corresponding to the access information from a first another information processing device;
a holding part for holding the access information so as to correspond to the action information received by the first receiver;
an acquiring part for acquiring the action information and an address of a device with which the action is performed;
a retriever for retrieving the access information corresponding to the action information from the information held by the holding part; and
a first transmitter for transmitting the address acquired by the acquiring part and the access information retrieved by the retriever to a second another information processing device.

36. An information processing device according to claim 35, further comprising a second transmitter for transmitting a processable action to the first another information processing device.

37. An information processing device according to claim 35, further comprising:
a second receiver for receiving the access information and an ID corresponding to the access information from the first another information processing device;
a second retriever for retrieving the same access information as the access information received by the second receiver, from the holding part; and
a storing part for storing the ID so as to correspond to the access information retrieved by the second retriever.

38. An information processing method for an information processing device for detecting action information, the method comprising:
receiving access information and action information corresponding to the access information from a first another information processing device;
holding the access information so as to correspond to the action information received in the processing of the step of receiving;
acquiring an address of a device with which an action was performed and the action information;
retrieving the access information corresponding to the action information from the information held in the processing of the step of holding; and
transmitting the address acquired in the processing of the step of acquiring and the access information retrieved in the processing of the step of retrieving to a second another information processing device.

39. A program storage medium in which a computer-readable program for an information processing device for detecting action information is stored, the program comprising:
a receiving step of receiving access information and action information corresponding to the access information from a first another information processing device;
a hold controlling step of controlling holding of the access information so as to correspond to the action information received in the processing of the receiving step;
an acquisition controlling step of controlling acquisition of an address of a device with which an action was performed and the action information;
a retrieving step of retrieving the access information corresponding to the action information from the information held in the processing of the hold controlling step; and
a transmitting step of transmitting the address acquired in the processing of the acquisition controlling step and the access information retrieved in the processing of the retrieving step to a second another information processing device.

40. A program for a computer that controls an information processing device for detecting action information, the program causing the computer to execute:
a receiving step of receiving access information and action information corresponding to the access information from a first another information processing device;
a hold controlling step of controlling holding of the access information so as to correspond to the action information received in the processing of the first receiving step;
an acquisition controlling step of controlling acquisition of an address of a device with which an action was performed and the action information;
a retrieving step of retrieving the access information corresponding to the action information from the information held in the processing of the hold controlling step; and
a transmitting step of transmitting the address acquired in the processing of the acquisition controlling step and the access information retrieved in the processing of the retrieving step to a second another information processing device.
